(19) United States
(12) Patent Application Publication
(10) Pub. No.: US 2023/0351174 A1
(43) Pub. Date: Nov. 2, 2023

(54) METHOD OF AUTOMATICALLY CREATING AI DIAGNOSTIC MODEL FOR DIAGNOSING ABNORMAL STATE BASED ON NOISE AND VIBRATION DATA TO WHICH ENAS IS APPLIED

(71) Applicants: Hyundai Motor Company, Seoul (KR); Kia Corporation, Seoul (KR); IUCF-HYU (Industry-University Cooperation Foundation Hanyang University, Seoul (KR)

(72) Inventors: Dong-Chul Lee, Anyang-si (KR); In-Soo Jung, Goyang-si (KR); Joo-Hyun Lee, Seoul (KR); Joon-Hyuk Chang, Seoul (KR); Kyoung-Jin Noh, Seoul (KR)

(21) Appl. No.: 17/949,441

(22) Filed: Sep. 21, 2022

(30) Foreign Application Priority Data
Apr. 27, 2022 (KR) 1020220052223

(51) Int. Cl. G06N 3/08; G07C 5/08

(52) U.S. Cl. CPC G06N 3/08; G07C 5/0808

(57) ABSTRACT

A method of automatically creating an artificial intelligence (AI) diagnostic model for diagnosing an abnormal state of a vehicle includes: acquiring noise and vibration data measured by a sensor of the vehicle as input data, processing the input data, searching and selecting an architecture of the AI diagnostic model based on the processed input data, and providing the AI diagnostic model to diagnose the abnormal state of the vehicle, where an efficient neural architecture search (ENAS) is applied to update the AI diagnostic model and a parameter configuring the AI diagnostic model, the ENAS sharing the parameter with the updated AI diagnostic model.

### CROSS-REFERENCE TO RELATED APPLICATION

This application claims priority to Korean Patent Application No. 10-2022-0052223, filed on Apr. 27, 2022, which is incorporated herein by reference in its entirety.

### TECHNICAL FIELD

The present disclosure relates to a method of automatically creating an AI diagnostic model for diagnosing an abnormal state of a part to which an ENAS is applied based on noise and vibration data using the ENAS in order to automatically design the AI diagnostic model.

### BACKGROUND

Until now, it has been pursuing better results by analyzing the data acquired based on the sensor, such as a specific sensor value or a threshold of a signal to analyze an abnormal state of a system or a mechanical device to be observed, and applying AI.

However, when a diagnostic model based on AI is used, the reason why a diagnostic algorithm that relies on the developer's know-how is mainly applied is that diagnostic performance has been exerted for and applied to only a specific problem in which the developer's knowhow is concentrated other than the whole. Accordingly, as data familiar to the developers is repeatedly acquired and analyzed, a problem of data over-fitting may occur.

Accordingly, when a new problem situation occurs, it is necessary to verify whether the model is an optimized model after a new model is configured, and thus a huge amount of computation may be required. Accordingly, as a series of processes are automated, there is a need for a technique of creating a more optimized model without relying on developer's know-how.

### SUMMARY

An object of the present disclosure is to provide a method of automatically creating an AI diagnostic model for diagnosing an abnormal state based on noise and vibration data using an AI diagnostic model (Deep Learning Model) automatic optimization generation technology to which an efficient neural architecture search (ENAS) technology is applied and a framework tool.

In order to achieve the object, there is provided a method of automatically creating an AI diagnostic model for diagnosing an abnormal state based on noise and vibration data to which an ENAS is applied according to one embodiment of the present disclosure, the method including: acquiring the noise and vibration data as input data from a sensor of a vehicle (S10), processing the input data (S20), extracting a feature (S30), selecting a combination of features suitable for the AI diagnostic model from the extracted feature (S40), searching for and selecting an architecture of the AI diagnostic model (S50), and optimizing the architecture of the AI diagnostic model (S60), in which in the searching for and selecting (S50) and optimizing (S60) the architecture of the AI diagnostic model, when the AI diagnostic model first calculated and a parameter configuring the AI diagnostic model are based on an efficient neural architecture search (ENAS) and the AI diagnostic model is updated, the parameter is shared.

There is provided a method of automatically creating an AI diagnostic model for diagnosing an abnormal state based on noise and vibration data to which an ENAS is applied according to another embodiment of the present disclosure, the method including: acquiring the noise and vibration data of a vehicle as input data by a sensor (S10), processing the input data (S20), extracting a feature from the processed input data (S30), selecting a combination of features suitable for the AI diagnostic model from the extracted feature (S40), searching for and selecting an architecture of the AI diagnostic model (S50), optimizing the architecture of the AI diagnostic model (S60), validating the AI diagnostic model that terminates a training process when a change rate of accuracy converges to a certain level or less, even when the accuracy is higher than a certain level, and a larger number of layers are added according to a change in the depth of the AI diagnostic model (S70), and providing the AI diagnostic model to diagnose the abnormal state of the vehicle, in which when the AI diagnostic model first calculated and a parameter configuring the AI diagnostic model are based on an efficient neural architecture search (ENAS) and the AI diagnostic model is updated, the parameter is shared.

The method of automatically creating the AI diagnostic model for diagnosing an abnormal state based on noise and vibration data to which an ENAS is applied according to the present disclosure can automatically create the Deep Learning model with high robustness by optimizing performance of the objective generation model other than relying on the AI developer's knowhow.

In addition, it is possible to expand the efficient neural architecture search (ENAS) technology capable of having the GPU with the small capacity and quickly generating the model compared to the neural architecture search (NAS) technique to the field of diagnosing the abnormal state of vehicles.

### BRIEF DESCRIPTION OF THE DRAWINGS

FIG. 1 is an entire block view of the present disclosure.

FIG. 2 is a block view of an automated feature learning stage and a stage to which an ENAS is applied.

FIG. 3 is a block view configuring a model selecting stage (S50).

FIG. 4 is a conceptual view of a stage to which the ENAS is applied.

### DETAILED DESCRIPTION

A specific content for carrying out the present disclosure will be described with reference to the drawings.

A neural architecture search as a type of an auto machine learning (AutoML), which refers to an automated machine learning modeling, is an automated tool as well as an automatic generation methodology that optimizes a neural architecture configuring an AI machine learning model, and is a technique of searching for an optimal artificial neural architecture by training a neural network derived through a recurrent neural network (RNN).

The neural architecture search can search for the optimal artificial neural architecture by training the neural network derived through the recurrent neural network. The RNN controller can serve to create neural architecture candidates, train the neural architecture, and measure performance. Measurement results can help finding a better neural architecture. The RNN controller can enable the neural architecture to converge to a specific model among neural architecture candidates through training, and in this process, the accuracy of the neural architecture of a neural architecture candidate group is used as a reward signal.

In some examples, the neural architecture candidate group created by the RNN controller—this is referred to as a child model—removes all of trained weights, and thus the amount of computation is significantly increased because a new training is performed every time the model is newly created.

The neural architecture search can create and complete to train an unlimited model architecture and then initialize all parameters. Accordingly, the time required for training the model may increase exponentially, thereby reducing a probability of determining the accuracy of the model until final model performance is checked.

The ENAS can refer to an efficient neural architecture search. The ENAS can be characterized by searching for an architecture combination for a specified model depth, and sharing parameters of each model architecture from an initial model to a model subsequently calculated. For example, a classification model of the type such as noise and vibration data based on the ENAS can be optimized within a set model architecture depth, and the development time can be shortened and performance can be easily checked by a technique of having only the best algorithm and optimizing each parameter.

The ENAS and reinforced training can be applied in automating the AI diagnostic model for diagnosing the abnormal state based on noise and vibration data of a vehicle acquired from a sensor.

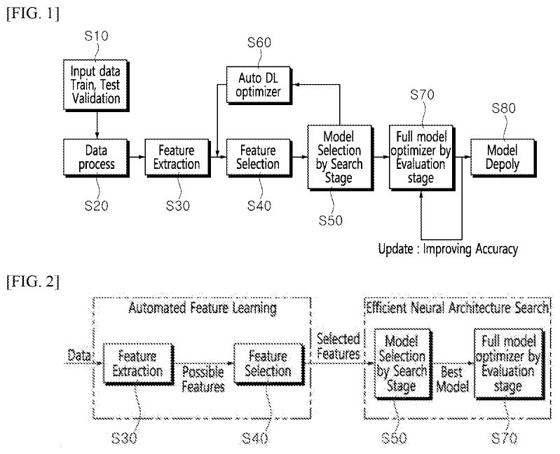

FIG. 1 is an entire block view of the present disclosure to which the ENAS is applied.

A stage (S10) can include, as input data acquired from the sensor, data classified into training data, test data, and validation data. Noise and vibration data can be measured or collected by using a sensor outside a vehicle or by installing a sensor inside a vehicle, and the collected data can be stored in a separate storage device or an external server and then also fetched when the diagnostic model is trained.

The training data can be used for training the model. The validation data can be used for checking performance in the middle of training the model, and used for updating the model along with the training data. The test data can be used for validating the constructed AI diagnostic model.

S20 represents a data processing process, and a dataset is determined as a data pre-formatting stage. The dataset used in the present disclosure is a noise dataset or a vibration dataset, and includes, for example, noise or vibration data (dB) over time (t) measured in a vehicle.

Through the stage (S20), the appropriateness of the data is determined as to whether it is high-quality data with low disturbance among the noise or vibration data collected by type. A sampling rate is matched, and to this end, a resampling can be performed again. A high/low/band pass filter can also be selectively applied as a frequency filter.

Algorithms used for the data processing can be selectively used from a Crop that removes noise through visual inspection and unifies the length between data when data is input, a resampling that unifies the entire data sampling rate, a harmonic/percussive sound separation (HPSS) that separates and extracts high/low/band pass filter, harmonic, percussive waveform components that removes or extracts specific frequency bands, a normalization that automatically performs a data value scaling, an outlier detection that is mainly used in a CAN and detects and removes outliers, and a PCA that reduces dimensions.

Through the stages (S10 and S20), a preparation for performing the ENAS framework can be completed.

S30 is a feature extracting stage, and one or a combination of various filter techniques and signal processing techniques for extracting the feature may be selected to be used for extracting the features. For example, techniques such as FFT, Mel-spectrogram, and HPSS may be used. A magnitude value of an important frequency band of a target noise may be transformed into a dB-scale and used as a feature vector using the Fast Fourier Transform (FFT). The Mel-spectrogram may use as the feature vector the spectrogram in which the FFT-transformed spectrogram is transformed in an Mel unit by applying a Mel-filter bank to a frequency axis. The harmonic-percussive source separation (HPSS) separates the harmonic and percussive components on the frequency axis with respect to the spectrogram after FFT, then separates an H component by applying a horizontal median filter along the frequency axis, and separates a P component by applying a vertical median filter along a time axis. A binary mask may be created by applying a threshold to an H/P or P/H rate, and an STFT coefficient of an input signal and the binary mask may be subjected to element-wise multiplication to finally separate the H and P components. As described above, three feature extraction techniques are applied, and among them, one or two or more features may be applied to the model.

S40 is a feature selecting stage, and selects a combination of the features suitable for modeling to reflect the selected feature to the ENAS modeling. A combination with the best reward signal (accuracy) is searched and reflected as every epoch of the training dataset is performed.

S50 is a stage of serving to set structures of a normal cell and a reduction cell that are a unit model in the RNN controller serving as an agent of the ENAS. The unit model can refer to a model composed of a pair of normal cell and reduction cell, and this is the basis of a full model of S70 expanded to multiple layers.

In S50, the Deep Learning model is optimized based on the efficient neural architecture search (ENAS). In searching for and selecting the structure for constructing the model within the range where computational performance is possible of a server in which computation is performed, the efficient neural architecture search (ENAS), which is an efficient model search technique through sharing of the model parameter, is applied.

S60 is a process of increasing accuracy through the optimization of the unit model composed of the normal cell and the reduction cell by updating the setting of the parameter of the model created by the RNN controller and a hyper-parameter.

By repeatedly performing the stages (S40, S50, and S60), the optimal unit model can be automatically created, and when the model in which accuracy is converged is found, the unit model can be finished by an early stopping.

S70 creates the full model having a deep model architecture layer using the unit model searched in S50 described above, and at this time, accuracy is improved with an automated region in which the sequence and number of normal cells and the reduction cells are optimized using a grid search. In the process of S70, all parameters updated in the unit model is initialized and only the architecture is created, and the parameter is updated and optimized by training the full model again in order to improve accuracy. In the process of S70, the full model is combined by initializing all parameters updated in the unit model and creating only the architecture, the initialized parameter is updated to optimize the full model again in order to improve accuracy, and when a certain accuracy is reached, it proceeds to stage S80.

S80 is a stage in which the final diagnostic model of the ENAS is provided in the form of API in which codes are implemented so that computation and execution are performed in the server, or stored in the form of file for each device in the form of execution file such as the form (Android, C++, C language, etc.) suitable for device environments to be used in a user's device.

FIG. 2 shows the feature selecting stage (S40) that combines available features from the feature extracting stage (S30) to which the ENAS is applied in the automated Deep Learning modeling process. The feature extracting stage (S30) and the feature selecting stage (S40) are an automated feature learning stage. An AI diagnostic model is created by using training data among the input data, and the above stage is a process of finding a combination of features in which the classification category distinction between features is well expressed through the training data, in particularly, using some of all training data.

FIG. 2 shows a stage of searching for and selecting the unit model (S50) by the selected features and a stage of searching for a neutral architecture from the unit model of S50, and evaluating the created model by the neural architecture search (S70) in order to find the best model.

The stage of searching for and selecting the unit model (S50) shown in FIG. 2 is a stage of searching for and selecting the architecture of the unit model (normal cell/reduction cell) with excellent performance through an ENAS algorithm, and the stage of selecting the full model (S70) is shown as selecting the full model, which is the best model, from the unit model (S70).

The stage of searching for and selecting the unit model in S50 is a process of increasing accuracy by updating the parameters of the model set by the RNN controller using the training data, and the accuracy is confirmed with the validation data among the input data, and this value is selected as the reward signal to perform training in a direction in which the reward signal becomes better (improved) and search for the architecture of the unit model. A deep model architecture layer is created by using the searched unit model, and at this time, as an automated region in which the order and number of normal cells and reduction cells are optimized by using a Grid Search, in this stage, all updated parameters of the unit model are initialized and only the architecture is created to update the parameters by training the full model again and optimize the model.

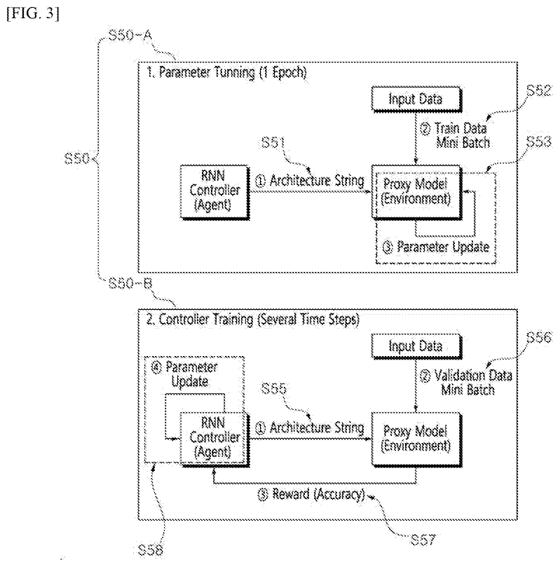

FIG. 3 is a conceptual view showing that the stage of searching for and selecting the model (S50) to which the ENAS is applied is further subdivided. The stage of selecting the model of FIG. 3 is a process of searching for and training the model architecture, and is classified into a parameter tuning stage (S50-A) and a controller training stage (S50-B). The process of searching for and training the model architecture targets 1 Epoch, and 1 Epoch means the entire training data.

The parameter tuning stage (S50-A) is composed of a stage of creating a proxy model in an environment by creating an architecture string by the RNN controller that is an agent (S51), a stage of transmitting the training data among the input data to the proxy model with a mini-batch (S52), and a stage of updating the parameters in the proxy model (S53).

In other words, the proxy model of the environment is a training mode, and the RNN controller is set to a validation mode as the agent. The RNN controller serves to sample the architecture string by a combination of operation (arithmetic operations or calculation) and data flow for each mini-batch for the training data among the input data. In the Deep Learning, a batch means a bundle of samples used to update the weight of the model once. Compared to a batch that trains the entire data, the mini-batch perform training by a method that divides the entire data into N to dispose each training data, and the mini-batch can reduce the time compared to the batch.

The model architecture is changed by transmitting the sampled architecture string to the proxy model of the environment, and data of the mini-batch size is input to the changed proxy model.

Since the RNN controller samples the random model architecture at the beginning of the parameter tuning stage (S50-A), most of the parameter values of the proxy model should be tuned. As the search proceeds, the output of the RNN controller gradually converges to one form, and only the frequently used parameter values of the proxy model are updated.

The controller training stage (S50-B) is composed of a stage of transmitting the sampled architecture string to the proxy model of the environment by the RNN controller that is an agent (S55), a stage of transmitting the validation data among the input data to the proxy model with the mini-batch (S56), a stage of measuring accuracy in the proxy model with changed architecture (S57), and a stage of updating the parameters using the measured accuracy as the reward of the reinforced training by the RNN controller (S58). In other words, in the controller training stage (S50-B), the proxy model is the validation mode, and the RNN controller is set to the training mode. The RNN controller changes the architecture of the proxy model by transmitting the sampled architecture string to the proxy model whose parameters are optimized to some extent. The accuracy within the mini-batch is output by inputting the validation data among the input data to the changed proxy model with the mini-batch. The accuracy may be measured for each changed architecture of the proxy model, the parameter values are updated by the reinforced training that performs rewards to increase the measured accuracy, and the RNN controller is trained.

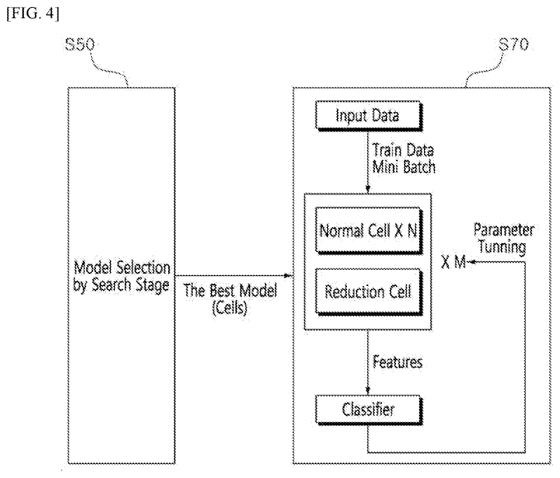

FIG. 4 shows the stage of searching for the architecture of the unit model (normal cell/reduction cell) with excellent performance through the ENAS algorithm in the stage of searching for and selecting the unit model (S50) shown in FIG. 2, and the configuration of the full model, which is the best model, from the unit model (S70).

The architecture of the full model in the stage of searching for and selecting the model (S50) is composed of a smaller number of layers than the model architecture in the stage of validating the model (S70). A parameter in each operation (Edge computing) consumes memory. Thus, in the stage of searching for and selecting the model (S50), the model is configured to reduce the number of layers, and after the stage of searching for the model is completed, in the stage of validating the model (S70), the model is trained by a number of found cell architectures that is more than the number of layers in the stage of searching for the model.

A technique applied to the stage of validating the model (S70) may select a change in the depth of the unit model by applying a change in a learning rate and a grid search technique. The accuracy is higher than a certain level, and when a change rate of the accuracy converges to a certain level or less even when more layers are configured depending on a change in the depth of the model, the training process is terminated.

In the stage of validating the model (S70), the full model is configured by tuning the parameter while repeating the N normal cells and one reduction cell M times (M, N are a natural number) from the unit model, that is, the normal cell and the reduction cell found in the stage of searching for and selecting the model (S50).

Deep Learning generalization techniques such as a data augmentation, a cosine annealing schedule, and an auxiliary head are used to maximize performance of the model. The trend of the change in accuracy can be searched and the accuracy is higher than the certain level, and when a change rate of the accuracy converges to a certain level or less even when more layers are configured depending on a change in the depth of the model, the training process can be terminated, thereby shortening the operation time.

According to the present disclosure, the ENAS is reconfigured to be optimized for noise and diagnostic tasks based on the Inception module of Google Net as the architectural feature of the layer of the model. The present disclosure intends to find the operation combination of the Inception module in consideration of the characteristics of the vehicle domain and the characteristics of noise and vibration signals.

In order to configure one layer, an optimal combination of N multiple different types of operations is formed to form a layer. There are many types of operations such as identity, 3×3 convolution, 5×5 convolution, average pooling, and max pooling.

According to the present disclosure, in the loss function, the model is trained through the cross entropy loss using the stochastic gradient decent. Complex tasks use a combination of mean squared error (MSE), root mean squared error (RMSE), binary cross entropy, categorical cross entropy, and sparse categorical cross entropy loss functions. Furthermore, it is also possible to use the loss function to which the weight is applied by applying the ensemble method.

What is claimed is:

1. A method of automatically creating an artificial intelligence (AI) diagnostic model for diagnosing an abnormal state of a vehicle, the method comprising:
acquiring noise and vibration data measured by a sensor of the vehicle as input data;
processing the input data;
searching and selecting an architecture of the AI diagnostic model based on the processed input data; and
providing the AI diagnostic model to diagnose the abnormal state of the vehicle,
wherein an efficient neural architecture search (ENAS) is applied to update the AI diagnostic model and a parameter configuring the AI diagnostic model, the ENAS sharing the parameter with the updated AI diagnostic model.

2. The method of claim 1, wherein searching and selecting the architecture of the AI diagnostic model includes parameter tuning and controller training.

3. The method of claim 2, wherein the parameter tuning includes:
creating a sampled architecture string to transmit, to a proxy model, the created architecture string by a recurrent neural network (RNN) controller.

4. The method of claim 3, wherein the parameter tuning includes:
transmitting, to the proxy model, training data among the processed input data, the training data divided into a plurality of data.

5. The method of claim 4, wherein the parameter tuning includes:
updating the parameter in the proxy model.

6. The method of claim 2, wherein the controller training includes:
creating a sampled architecture string to transmit, to a proxy model, the created architecture string by a RNN controller.

7. The method of claim 6, wherein the controller training further includes:
transmitting, to the proxy model, validation data among the input data, the validation data divided into a plurality of data.

8. The method of claim 7, wherein the controller training further includes:
measuring accuracy in the proxy model with a different architecture of the AI diagnostic model.

9. The method of claim 8, wherein the controller training further includes:
updating a value of the parameter using a reinforced training that increases the measured accuracy by performing reinforcement leaning for a reward, and
training the RNN controller by the updated value of the parameter.

10. The method of claim 1, wherein searching and selecting the architecture of the AI diagnostic model includes:
searching for the AI diagnostic model that searches for a unit model including a normal cell and a reduction cell.

11. The method of claim 10, further comprising:
validating the AI diagnostic model,
wherein, based on (i) a level of accuracy of the AI diagnostic model being greater than a predefined level and (ii) a number of layers greater than or equal to a predefined number being added to the AI diagnostic model according to a change in a depth of the AI diagnostic model, a training process is terminated when a change rate of the accuracy converges to a level equal to or less than a predetermined level.

12. The method of claim 11,
wherein the AI diagnostic model is (i) provided as an API in a server or (ii) stored in a file as a user device environment.

13. A method of automatically creating an artificial intelligence (AI) diagnostic model for diagnosing an abnormal state of a vehicle, the method comprising:
acquiring noise and vibration data measured by a sensor of the vehicle as input data;
processing the input data;
extracting one or more features from the processed input data;
selecting a combination of features suitable for the AI diagnostic model from the extracted one or more features;
searching and selecting an architecture of the AI diagnostic model based on the processed input data;
optimizing the architecture of the AI diagnostic model based on a parameter;
validating the AI diagnostic model that is configured to, based on (i) accuracy of the AI diagnostic model being greater than a predefined level and (ii) a number of layers greater than or equal to a predefined number being added to the AI diagnostic model according to a change in a depth of the AI diagnostic model, terminate a training process when a change rate of the accuracy converges to a level equal to or less than a predetermined level; and
providing the AI diagnostic model to diagnose the abnormal state of the vehicle,
wherein an efficient neural architecture search (ENAS) is applied to update the AI diagnostic model and the parameter configuring the AI diagnostic model, the ENAS sharing the parameter with the updated AI diagnostic model.

14. The method of claim 13, wherein searching and selecting the architecture of the AI diagnostic model includes parameter tuning and controller training.

15. The method of claim 14, wherein the parameter tuning includes:
creating a sampled architecture string to transmit, to a proxy model, the created architecture string by a recurrent neural network (RNN) controller.

16. The method of claim 15, wherein the parameter tuning includes:
transmitting, to the proxy model, training data among the processed input data, the training data divided into a plurality of data.

17. The method of claim 16, wherein the parameter tuning includes:
updating the parameter in the proxy model.

18. The method of claim 14, wherein the controller training includes:
creating a sampled architecture string to transmit, to a proxy model, the created architecture string by a RNN controller.

19. The method of claim 18, wherein the controller training further includes:
transmitting, to the proxy model, validation data among the input data, the validation data divided into a plurality of data.

20. The method of claim 13,
wherein the AI diagnostic model is (i) provided as an API in a server or (ii) stored in a file as a user device environment.
